(19) United States
(12) Patent Application Publication
(10) Pub. No.: US 2010/0098284 A1
(43) Pub. Date: Apr. 22, 2010

(54) Apparatus And Method For Reducing Crosstalk Within A Microphone

(75) Inventors: Wade Forrest Conklin, Chicago, IL (US); John George Christopher, Elmhurst, IL (US)

Correspondence Address: FITCH EVEN TABIN & FLANNERY, 120 SOUTH LASALLE STREET, SUITE 1600, CHICAGO, IL, 60603-3406, US

(73) Assignee: KNOWLES ELECTRONICS, LLC, Itasca, IL (US)

(21) Appl. No.: 12/575,953

(22) Filed: Oct. 8, 2009

Related U.S. Application Data
(60) Provisional application No. 61/106,436, filed on Oct. 17, 2008.

(51) Int. Cl. H04R 17/02

(52) U.S. Cl. 381/369

(57) ABSTRACT

A microphone is provided. The microphone has a housing; a back plate positioned within the housing; a die positioned within the housing and coupled to a circuit board having conductive traces; and a conductive layer positioned between the die and the back plate, wherein the conductive layer mitigates coupling of an electrical signal between the conductive traces and the back plate.

### CROSS REFERENCE TO RELATED APPLICATION

This non-provisional application claims priority to U.S. Provisional Application No. 61/106,438 filed on Oct. 17, 2008 entitled “Apparatus and Method for Rejecting Crosstalk within a Microphone” the content of which is incorporated herein by reference in its entirety.

### TECHNICAL FIELD

This patent relates to an apparatus and method for reducing crosstalk within a microphone by placement of components on opposite sides of a ground potential within the microphone.

### BRIEF DESCRIPTION OF THE DRAWINGS

For a more complete understanding of the disclosure, reference should be made to the following detailed description and accompanying drawings wherein:

FIG. 1 illustrates a cutaway view of a microphone in an embodiment of the present invention;

FIG. 2 illustrates a cutaway view of the microphone of FIG. 1 emphasizing interactions between components; and

FIG. 3 is a chart comparing attenuation between microphone embodiments having a die located in two different areas of the microphone.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

In an embodiment, a microphone is provided. The microphone has a housing; a back plate positioned within the housing; a die positioned within the housing and coupled to a circuit board having conductive traces; and a conductive layer positioned between the die and the back plate, wherein the conductive layer mitigates coupling of an electrical signal between the conductive traces and the back plate.

In an embodiment, the die is a buffer circuit.

In an embodiment, the conductive layer is a printed conductive layer.

In another embodiment, a microphone is provided. The microphone has a housing; a back plate positioned within the housing; a die positioned within the housing and coupled to a circuit board having conductive traces; and a metal layer positioned between the die and the back plate, wherein the metal layer mitigates coupling of an electrical signal between the conductive traces and the back plate.

In an embodiment, the metal layer is conductive.

In an embodiment, the metal layer is a printed conductive layer.

In another embodiment, a microphone is provided. The microphone has a housing; a back plate positioned within the housing; a die positioned within the housing and coupled to a circuit board wherein conductive traces are adjacent to the die; and a metal layer positioned adjacent to the die, wherein the metal layer mitigates coupling of an electrical signal between the conductive traces and the back plate.

In an embodiment, the metal layer is conductive.

In yet another embodiment, a microphone is provided. The microphone has a housing; a back plate positioned within the housing; a die positioned within the housing and coupled to a circuit board wherein conductive traces are adjacent to the die; and a conductive layer positioned adjacent to the die, wherein the conductive layer mitigates coupling of an electrical signal between the conductive traces and the back plate.

In an embodiment, the conductive layer is a printed conductive layer.

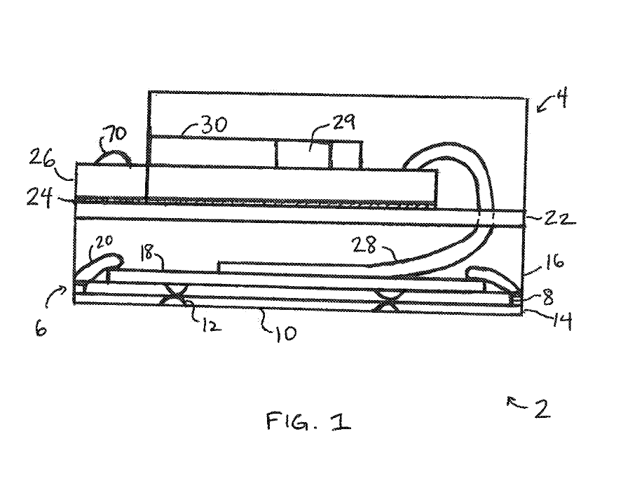

FIG. 1 illustrates a microphone 2 of the present invention. The microphone 2 may have a top cup 4 which may be constructed from materials such as, for example, stainless steel. The microphone 2 may have a bottom cup 6 which may be constructed from stainless steel, or the like. The top cup 4 may have a length in a range from 0.108 inches to 0.110 inches; a width in a range from 0.139 inches to 0.142 inches; and a height in a range from 0.03475 inches to 0.03725 inches. The bottom cup 6 may have a length and width in a range from 0.139 inches to 0.141 inches; and a height in a range from 0.0447 inches to 0.0473 inches.

Located within the microphone 2 are various components. A diaphragm 8 may be positioned adjacent a bottom surface 10 of the bottom cup 6. The diaphragm 8 may be constructed from mylar. The diaphragm 8 may have a diameter in a range from 0.1265 inches to 0.1275 inches. The diaphragm 8 may rest upon a ridge 12 created on the bottom surface 10. A sound or acoustic port 14 may exist adjacent the bottom surface 10 on a side 16 of the bottom cup 6. The diaphragm may be attached to a backplate 18 by a fastener 20. In an embodiment, the fastener 20 is stitch cement; however, other methods of fastening are contemplated that are known to those skilled in the art. The backplate 18 may be constructed from teflon-coated stainless steel, or the like and may have a length and width in a range from 0.0940 inches to 0.0950 inches.

An intermediate plate 22 separates the top cup 4 and the bottom cup 6. The intermediate layer 22 may be constructed from stainless steel or the like. The intermediate layer 22 may have a thickness in a range from 0.0025 inches to 0.0035 inches. The intermediate plate 22 may extend for an entire length of an interior of the bottom cup 6. Positioned on the intermediate plate 22 may be a circuit board 26 which may have a printed conductor layer 24 on a bottom surface which is at ground potential. The circuit board 26 may be constructed from alumina or a like material. A wire 28 may extend from the backplate 18 to the circuit board 26 to provide an electrical connection. In addition, one or more pads 70 are in connection with the circuit board 26 to provide an external connection to, for example, an end user product.

A buffer amplifier 29, or other type of die, may be positioned on and attached to the circuit board 26. A second die 30, such as one used to sense a magnetic field, may be positioned on the circuit board 26, adjacent to the buffer amplifier 29. The dice 29, 30 may be fastened or attached to the circuit board 26 using any method contemplated by those of skill in the art.

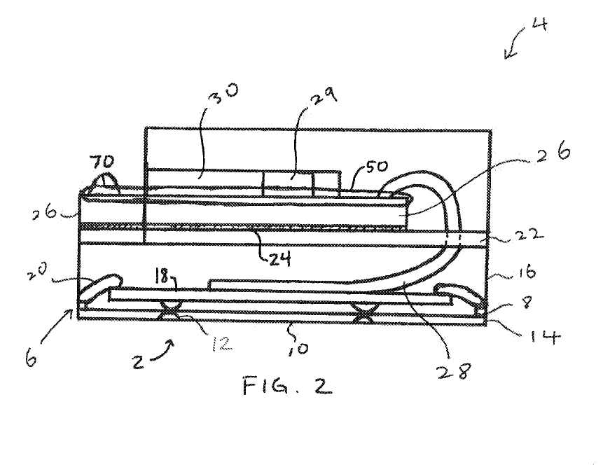

Turning to FIG. 2, an interaction between the various components of the microphone is illustrated. More specifically, a plane of conductivity 50 is identified. This plane of conductivity 50 encompasses the region from which a source signal is emitted when a voltage is applied to the pad 70 in connection with conductive traces. When the signal is emitted, capacitive coupling occurs between the conductive trace and the backplate 18. By placing the printed conductor layer 24 at ground potential between the plane of conductivity 50 and the backplate 18 (which acts as a receiver of signals), coupling of the signal from the plane of conductivity 50 to the backplate 18 is mitigated, thereby mitigating crosstalk.

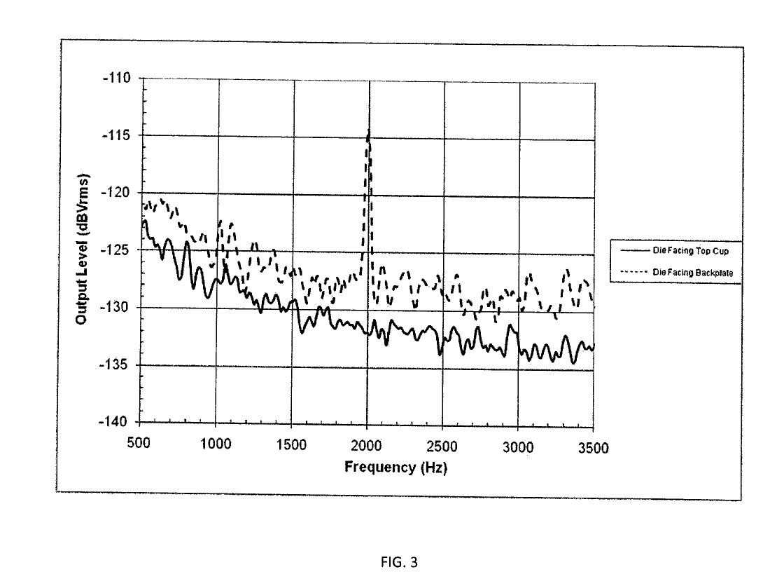

It was observed that in microphone embodiments in which a die was positioned adjacent to a backplate, a signal would be observed on the output of a microphone when an interfering signal at the same frequency was applied to one of the conductive traces on the circuit board. Accordingly, by placing the die on the side of the circuit board away from the backplate, the ground potential layer of the circuit board acted as a shield preventing capacitive coupling to microphone's backplate. Thus, two conclusions can be reached. First, the capacitive coupling between the conductive traces and backplate was the significant source of the signal observed at the output. Second, introducing a ground potential plane between the conductive trace the signal resided on, and the backplate, significantly mitigated the signal observed on the microphone output. The curves in FIG. 3 illustrate the results of positioning the die adjacent to a backplate (labeled “die facing backplate”) and on the side of the circuit away from the backplate (labeled “die facing top cup”) when a 2 kHz voltage signal at 10 mVrms is introduced, i.e., applied to one of the conductive traces via a pad of the circuit board. FIG. 3 shows that the microphone output due to the voltage signal at 2 kHz is less than the magnitude of the noise outputted by the microphone at approximately 2 kHz when the die is positioned on the side of the circuit away from the backplate. It should be noted that, in an embodiment, the intermediate plate may not be necessary to mitigating coupling of the electrical signal; this function may be performed by the conductive layer of the circuit board. Conversely, the conductive layer may not be needed, in an embodiment, to mitigate the coupling; instead, the intermediate layer may provide that function.

Preferred embodiments of this invention are described herein, including the best mode known to the inventors for carrying out the invention. It should be understood that the illustrated embodiments are exemplary only, and should not be taken as limiting the scope of the invention.

We claim:

1. A microphone comprising:
a housing;
a back plate positioned within the housing;
a die positioned within the housing and coupled to a circuit board having conductive traces; and
a conductive layer positioned between the die and the back plate, wherein the conductive layer mitigates coupling of an electrical signal between the conductive traces and the back plate.

2. The microphone of claim 1 wherein the die is a buffer circuit.

3. The microphone of claim 1 wherein the conductive layer is a printed conductive layer.

4. A microphone comprising:
a housing;
a back plate positioned within the housing;
a die positioned within the housing and coupled to a circuit board having conductive traces; and
a metal layer positioned between the die and the back plate, wherein the metal layer mitigates coupling of an electrical signal between the conductive traces and the back plate.

5. The microphone of claim 4 wherein the metal layer is conductive.

6. The microphone of claim 5 wherein the metal layer is a printed conductive layer.

7. A microphone comprising:
a housing;
a back plate positioned within the housing;
a die positioned within the housing and coupled to a circuit board wherein conductive traces are adjacent to the die; and
a metal layer positioned adjacent to the die, wherein the metal layer mitigates coupling of an electrical signal between the conductive traces and the back plate.

8. The microphone of claim 7 wherein the metal layer is conductive.

9. A microphone comprising:
a housing;
a back plate positioned within the housing;
a die positioned within the housing and coupled to a circuit board wherein conductive traces are adjacent to the die; and
a conductive layer positioned adjacent to the die, wherein the conductive layer mitigates coupling of an electrical signal between the conductive traces and the back plate.

10. The microphone of claim 9 wherein the conductive layer is a printed conductive layer.
